(19) United States
(12) Patent Application Publication
(10) Pub. No.: US 2026/0243328 A1
(43) Pub. Date: Aug. 20, 2026

(54) GEAR ASSEMBLY

(71) Applicant: Precision Technologies Group (PTG) Limited, Rochdale, Lancashire (GB)

(72) Inventors: Robert Munro, Rochdale, Lancashire (GB); Daniel Johnson, Rochdale Lancashire (GB)

(73) Assignee: Precision Technologies Group (PTG) Limited, Rochdale, Lancashire (GB)

(21) Appl. No.: 19/480,454

(22) PCT Filed: May 2, 2024
(86) PCT No.: PCT/GB2024/051162

§ 371 Date: Oct. 31, 2025

(30) Foreign Application Priority Data
May 3, 2023 (GB) 2306561.8

(51) Int. Cl. F16H 1/00; F16H 1/08; F16H 55/08; F16H 57/022

(52) U.S. Cl. CPC F16H 1/006; F16H 1/08; F16H 55/0826; F16H 57/022; F16H 2057/0222

(57) ABSTRACT

A gear assembly comprising a first gear and a second gear. The gears are complementary conformal gears. The gears are supported for rotation about respective rotation axes extending through respective centres of the gears. One of the gears is configured to exert a driving force on the other of the gears. The gear assembly has an optimum centre distance corresponding to an optimum separation of the centres of the first and the second gears. The first gear is supported by a mounting that allows movement of the first gear towards and/or away from the second gear to minimise any difference between the separation of the centres of the first and second gears, and the optimum centre distance, during use of the gear assembly.

The present invention relates to a gear assembly. The invention has particular, but not exclusive, application to the gearboxes which are subjected to significant changes in geometry, for instance due to thermal expansion or changes in load.

Conformal gears are well known in the art. Conformal gears are pairs of helical gears where a convex length of a tooth flank meshes with a concave length of the engaging tooth flank. The profile of a tooth is the shape of the tooth flank when it is sectioned by a transverse plane, which is a plane normal to the axis of rotation of the gear. In conformal gears the profiles of the two gears in mesh are coincident or very close to being coincident over the whole length of the flank. For example, in Wildhaber-Novikov (W-N) gears the profiles are generally circular arcs where the radius of the arc on the concave tooth may be around 2% greater than the radius of the arc on the convex tooth.

It is to be understood that reference herein to pairs of conformal gears is intended to include any pair of gears which falls within the above definition, including pairs of gears which may conventionally be referred to by a different name, for example, W-N gears, double circular arc gears or gears with conformal profiles which are not in the shape of circular arcs.

In meshed pairs of involute gears, the teeth of the two gears both have convex profiles. At any point in time, the teeth contact each other at a discrete point across their respective heights, and roll across each other as the gears rotate. In conformal gears, however, the flanks of meshed teeth are complementary and contact one another across a line of contact which runs at least part way up the flanks of the teeth in question. The teeth of the gears act on each other in an action called ‘culmination’, which relies on the helical shape of the gears—a pair of meshed teeth contact each other, along the line of contact, at a particular point along the axial length of the gears. As the gears rotate, this line of contact moves axially along the gears, along the flanks of the teeth in question.

Conformal gears can provide several advantages over conventional gears such as involute gears. For instance, the tooth contact stresses can be much reduced because the mating tooth profiles have almost perfect conformity. By contrast, the convex profiles of involute gear teeth result in much higher contact (Hertzian) stresses, which, together with their rolling action can lead to a surface failure mode referred to as ‘pitting’. Another potential advantage is that conformal gears' tooth profiles can produce a much greater oil film thickness between the teeth, thus reducing the risk of tooth surface failure known as ‘scoring’. A third potential benefit of conformal gears is that the roots of their teeth are wider than the teeth of equivalent involute gears, and thus have less concentrated stresses (such as bending stresses) in this region.

Meshed pairs of conformal gears are designed to transmit torque at a predetermined centre distance (the centre distance being the spacing between the gears' respective axes of rotation), herein referred to as an optimum centre distance. The optimum centre distance may be considered to be the centre distance at which the gears demonstrate the highest efficiency, performance or durability. In other words, the optimum centre distance is the centre distance at which the gear teeth profiles conform. At this position the separation between the convex and concave tooth surfaces is a minimum and the teeth of the gears may be considered to be ‘optimally meshed’. While pairs of meshed involute gears are relatively tolerant of changes in centre distance, because of the rolling action between their respective teeth, conformal gears only perform at their best when the centre distance is at the design value (i.e. at their optimum centre distance). Any deviation from this value can cause the contact to move toward one end of the conformal profiles. This may result in an increase in stress and reduction in service life.

One method used to mitigate this effect in Wildhaber-Novikov (W-N) gears is to give the concave ‘female’ tooth flanks a radius of curvature which is considerably larger (i.e. more than the 2% discussed above) than that of the convex ‘male’ tooth flanks. Although this allows the gears to be less sensitive to changes in centre distance, it also reduces the contact area even at the optimum centre distance, negating the above advantages offered by W-N gears over involute gears. At present, there is therefore a trade-off between efficiency, performance or durability and tolerance to changes in centre distance. Accordingly, conformal gears are not presently as widely used as may be expected given the above advantages over conventional gears.

It is one object of the present invention to mitigate or obviate at least one of the aforesaid disadvantages, and/or to provide an improved or alternative gear assembly.

According to the present invention there is provided a gear assembly comprising a first gear and a second gear, the gears being complementary conformal gears supported for rotation about respective rotation axes extending through respective centres of the gears, one of the gears being configured to exert a driving force on the other of said gears, the gear assembly having an optimum centre distance corresponding to an optimum separation of the centres of the first and the second gears, the first gear being supported by a mounting that allows movement of the first gear towards and/or away from the second gear to minimise any difference between the separation of the centres of the first and second gears, and the optimum centre distance, during use of the gear assembly.

It will be appreciated that during use the first and second gears may move towards and/or away from one another due to deflections of the shafts and/or supporting structures under load, and/or by thermal expansion and/or contraction, or from other causes. However, because the gears are complementary conformal gears, when the first gear has moved away from the second gear relative to the optimum centre distance (i.e. such that the gears are under-meshed) the design of the mounting in combination with the shape of the conformal gears will cause the first gear to be urged towards the second gear and towards the optimum centre distance. Likewise, when the first gear has moved towards the second gear relative to the optimum centre distance (i.e. such that the gears are over-meshed) the design of the mounting in combination with the shape of the conformal gears will cause the first gear to be urged away from the second gear and towards the optimum centre distance. Because the first gear is supported for movement towards and/or away from the second gear by the mounting, such urging of the first gear will result in a corresponding movement of the first gear towards the optimum centre distance. That is to say, the gear assembly utilises the design of the mounting in combination with the particular shape of conformal gears to provide a gear assembly with a self-adjusting centre distance. As such, optimum meshing between the first and second gears can always be achieved. Put another way, the mounting provides a means of mechanical compliance (freedom of movement) between the first and second gears (and systems of parallel gears, including but not limited to a pair of gears, a train of gears or a combination of gears operating in a planetary, epicyclic, or hypo-cyclic arrangement), to optimise the gear-to-gear contact conditions by a dynamic ‘self-adjusting’ mechanism. This provides the advantages of:
Increased power/torque transmission capability relative to the dimensions of the gears and/or a gearbox (to allow more power through a smaller gear set);
Improved ability to tolerate/correct for misalignment of the gears and any sub-optimal contact resulting from the operational wear or overload;
Improved ability to tolerate/correct for misalignment of the gears and any sub-optimal contact due to manufacturing errors;
Reduced manufacturing cost by allowing larger tolerances;
Allowing a mesh centre-distance and pressure angle to self-adjust in response to operating forces on the gears (including external load, wear, thermal distortion and shock).

The mounting allows for at least one of the following conditions to be achieved: the transmission accuracy to be maximised, the transmission error to be minimised, and the efficient transmission of torque (or power). Transmission accuracy and transmission error refer to the rotational relationship (or rotation-linear in the case of a rack and pinion) between the gears. That is to say, a specific movement of the driving gear should result in a corresponding predictable and repeatable movement of the driven gear. The mounting promotes efficient transfer of power (or torque). By minimising transmission error distortion or wear of the gear axles and/or contact surfaces is mitigated.

The optimum centre distance may be the centre distance at which gear teeth profiles of the first and second gears make contact over the arc from the tooth tip of one gear to the tooth tip of the mating gear. In particular, the optimum centre distance may be the centre distance (i.e. the distance between the centre of the respective axles of two meshing gears) at which the transmission accuracy is maximised, and/or the transmission error is minimised, and/or the transmission of torque (or power) is close to, or at, peak efficiency.

The first gear may exert the driving force on the second gear or vice versa.

The mounting may comprise a support arm configured to rotatably support the first gear. That is to say, the first gear may be rotatable relative to the support arm. It will be appreciated that the support arm may have substantially any configuration which is able to support the first gear for rotation whilst permitting movement of the first gear towards and/or away from the second gear during use. For example, the support arm may be flexible, such that bending of the support arm permits movement of the first gear relative to the second gear. Such flexibility may be provided as a result of the cross-sectional shape, material composition, surface features or any other suitable characteristic of the support arm.

The support arm may be pivotable about an arm axis so as to move the first gear towards and/or away from the second gear.

The support arm may comprise a pivot pin, defining an arm axis about which the arm rotates, the arm axis being parallel to the rotation axis of the first gear.

The support arm may comprise a socket, the first gear may comprise an axle, and the axle may be rotatable within the socket. The socket may take the form of a loop which encircles the axle of the gear.

The mounting may comprise a plurality of support arms, for example two or more support arms.

The mounting may comprise at least one support surface. The first gear may comprise an axle which may rest on the support surface or which may be received in a bearing support which may rest on the support surface. The axle may be in direct contact with the support surface.

The first gear may be configured to rotate whilst in contact with the support surface. In particular, the axle of the first gear may be in direct contact with the support surface. Alternatively, if the axle is received in a support bearing which rests on the support surface, the first gear may be configured to rotate whilst in contact with the support bearing.

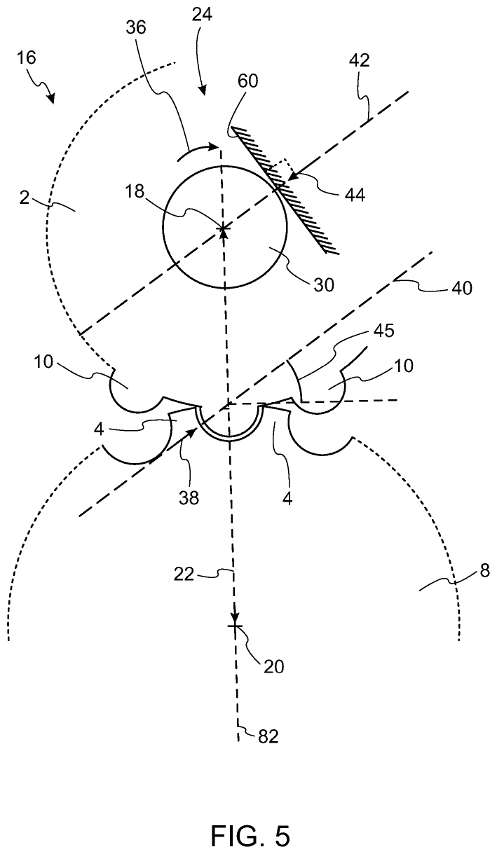

The axle may be at least partly received in a support, and the support rests on the support surface, such that the first gear may be configured to rotate whilst in contact with the support. The term support encompasses a mounting block or retaining element, which may allow for movement in a direction along the length of the gear axle. This is in contrast to roller bearings, where the bearing housing is in a fixed axial position relative to the gear axle. The support surface may be arranged so that the mounting allows the first gear to move along a predetermined line. The predetermined line may be linear (see, for example, the embodiment shown in FIG. 5 below), curved, stepped or any desirable combination such that the predetermined line along which the first gear moves can be accurately controlled to suit a particular application.

The axle may be able to run along the support surface or the support may be able to run along the support surface. In each case, consequently the axis of the first gear may be movable in a direction parallel to the support surface. In each case, the axle or support may maintain contact with the support surface through operation (rotation) of the gears, that is to say the axle or support does not rock into and out of contact with the support surface. The support surface may be flat (i.e. planar), concave, convex or any desirable combination of these forms so as to provide the required control of the movement of the first gear as it moves over the support surface to suit a particular application. The support surface may be rigid, flexible or include multiple zones where at least one zone is rigid while at least one other zone is flexible. The flexibility may be provided to facilitate bending of the support surface as the support moves over the support surface to permit movement of the first gear relative to the second gear. Such flexibility may be provided as a result of the cross-sectional shape, material composition, surface features or any other suitable characteristic of the support surface.

The mounting may comprise a plurality of support surfaces, for example two or more support surfaces.

According to the present invention there is provided a gear assembly comprising a first gear and a second gear, the gears being complementary conformal gears, such as W-N gears, supported for rotation about respective rotation axes, wherein:
one of the gears is configured to receive a drive torque and exert a driving tooth contact force, along a line of action, on the other of said gears via engagement of teeth of each of the first and second gears, so as to transmit the drive torque to the other of said gears, said other of the gears exerting a resistive tooth contact force to said one of the gears, along the line of action, as a consequence of the drive force;
the first gear is supported by a mounting which is configured to allow movement of the rotation axis of the first gear, and to exert a reaction force on the first gear in a reaction direction during transmission of the drive torque from said one of the gears to the other of the gears;
the first and second gears can take a first position relative to one another in which they have a first centre distance, and a second position in which they have a second centre distance;
the gear assembly is configured such that with the gears transmitting the drive torque while positioned in the second position, the line of action of the gears is not parallel to the reaction direction such that the reaction force, and the one of the driving tooth contact force and the resistive tooth contact force which is exerted on the first gear, produce a resultant force on the first gear; and
the resultant force urges the first gear to move relative to the second gear so as to move the gears away from the second position and towards the first position.

In other words, the resultant force urges the first gear to move relative to the second gear so that the centre distance of the gears approaches the first centre distance.

Such a gear assembly can be arranged such that a change in the centre distance from the first centre distance causes the first gear to be urged to move relative to the second gear so as to bring the centre distance back towards the first centre distance. For instance, an increase in centre distance may cause the first and second gears to be urged together, or a reduction in centre distance may cause the first and second gears to be urged apart. This may be beneficial in allowing the gear assembly to adapt itself to changes in the centre distance between the first and second gears, thereby reducing the effect on performance that such a change in centre distance would ordinarily produce. In other words, the gear assembly may utilise the particular shape of conformal gears (in particular the fact that this shape means that at centre distances near to the optimum, an increase in centre distance moves the line of action of the gears nearer to perpendicular to the gears' line of centres and a decrease in centre distance moves the line of action of the gears further from perpendicular to the gears' line of centres) to provide a pair of gears which self-adjust their centre distance.

A gear assembly with gears that can adapt to changes in centre distance (i.e. that can self-adjust) may provide beneficial simplicity in comparison to a system where the centre distance can be actively adjusted (for instance by a controller receiving signals from sensors), or a system where the centre distance of the first and second gears is controlled by the position of a third gear or other component.

A reaction force exerted on the first gear may be considered to be a resistive force exerted on the first gear by a body, as a result of the first gear being urged against the body and exerting a force thereon.

The first gear may be subjected to substantially no other forces during normal use (with the exception, for example, of forces brought about by inertia or by components' weight).

For the avoidance of doubt, reference to one of the gears transferring a drive torque to the other is not intended to imply that the gear is connected or connectable directly to a source of torque (although in some embodiments it may be). The term is merely used to indicate which gear of the pair drives the other to rotate.

The gear assembly may include additional gears, which may, for example, be installed in the form of a train of gears or in one or more sets of gears positioned in such a way as to transmit motion, power or torque using a plurality of gears, such as but not limited to, a planetary gear system whereby planet gears rotate about a sun gear.

The first centre distance may be substantially equal to the optimum centre distance of the first and second gears.

Such a gear assembly may allow the first gear to be positioned to a location in which its teeth are optimally meshed with those of the second gear, thereby allowing friction between the first and second gears to be minimised.

The first and second gears can take a third position relative to one another in which they have a third centre distance, the first centre distance being between the second and third centre distances;
the gear assembly may be configured such that with the gears transmitting the drive torque while arranged in the third position, the line of action of the gears is not parallel to the reaction direction such that the reaction force, and the one of the driving tooth contact force and the resistive tooth contact force which is exerted on the first gear, produce a resultant force on the first gear; and
the resultant force may urge the first gear to move relative to the second gear so as to move the gears away from the third position and towards the first position.

The second centre distance may be larger than the first centre distance, in which case the third centre distance would be smaller than the first centre distance. Alternatively, the second centre distance may be smaller than the first centre distance, in which case the third centre distance would be larger than the first centre distance.

Such a gear assembly may allow the positioning described above to take place if the gears are moved further apart than when in the first position, and also if the gears are moved closer to one another than when in the first position.

The gear assembly may be arranged such that, with the gears transmitting the drive torque while arranged in the first position, the line of action of the gears is substantially parallel to the reaction direction.

The mounting may comprise a support arm which is configured to rotatably support the first gear and which is pivotable about an arm axis, wherein the reaction direction is the direction between the arm axis and the axis of the first gear.

The first gear may be supported by a support surface, the reaction direction being perpendicular to the support surface, and the first gear being movable in a direction parallel to the support surface when supported by the support surface.

The support surface may be substantially flat (i.e. planar) when viewed in a plane that is normal to the axis of the first gear. The support surface may be concave, convex or any desirable combination of flat (i.e. planar), concave and convex so as to provide the required control of the movement of the first gear as it moves over the support surface to suit a particular application. The support surface may be rigid, flexible or include multiple zones where at least one zone is rigid while at least one other zone is flexible. The flexibility may be provided to facilitate bending of the support surface as the first gear moves over the support surface to permit movement of the first gear relative to the second gear. Such flexibility may be provided as a result of the cross-sectional shape, material composition, surface features or any other suitable characteristic of the support surface.

Said one of the gears may further be configured to receive an alternative drive torque and exert an alternative driving tooth contact force, along an alternative line of action, on the other of said gear via engagement of teeth of each of the first and second gears, so as to transmit the alternative drive torque to the other of the gears, the other gear exerting an alternative resistive tooth contact force to the one gear, along the alternative line of action, as a consequence of the alternative driving tooth contact force;
the mounting may further be configured to exert an alternative reaction force on the first gear in an alternative reaction direction during transmission of the alternative drive torque from the one of the gears to the other of the gears;
the gear assembly may be configured such that with the gears transmitting the alternative drive torque while arranged in the second position, the alternative line of action of the gears is not parallel to the alternative reaction direction such that the alternative reaction force, and the one of the alternative driving tooth contact force and
the alternative resistive tooth contact force which is exerted on the first gear, produce an alternative resultant force on the first gear; and the alternative resultant force may urge the first gear to move relative to the second gear so as to move the gears away from the second position and towards the first position.

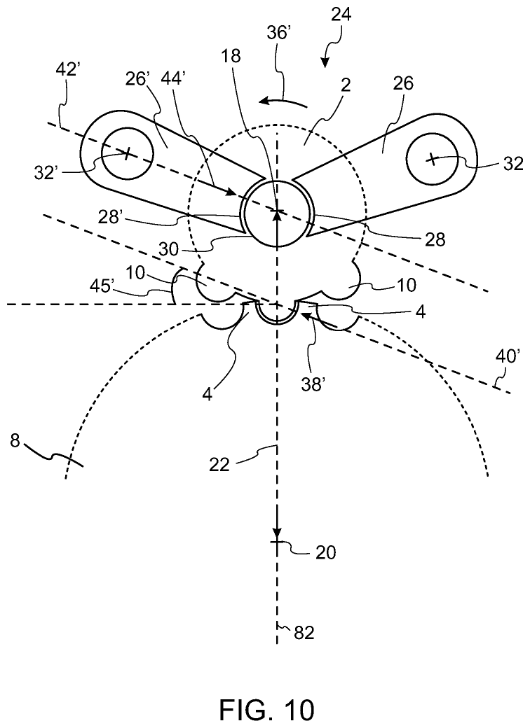

References herein to an “alternative drive torque” should be understood as including a drive torque that is different to the previously defined “drive torque” which is transmitted from the drive gear to the driven gear. The “alternative drive torque” may have a different, i.e. reverse, direction and/or magnitude to the previously defined “drive torque”. An example is set out below with reference to FIG. 10 where an “alternative drive torque” is applied, which results in a pair of gears counter-rotating in the opposite direction to when a “drive torque” is applied.

Such a gear assembly may provide one or more of the advantages of gears that can tolerate changes in centre distance discussed above, in relation to the transfer of torque in both directions rather than only in a single direction.

For the avoidance of doubt, reference to the gears being at a particular centre distance or in a particular position refers to their relative position, rather than absolute position.

Where said one of the gears is further configured to receive an alternative drive torque, and where the gear assembly is configured such that with the gears transmitting the drive torque while arranged in a third position:
the gear assembly may be configured such that with the gears transmitting the alternative drive torque while arranged in the third position, the alternative line of action of the gears is not parallel to the alternative reaction direction such that the alternative reaction force, and the one of the alternative driving tooth contact force and the alternative resistive tooth contact force which is exerted on the first gear, produce an alternative resultant force on the first gear; and
the alternative resultant force urges the first gear to move relative to the second gear so as to move the gears away from the third position and towards the first position.

The gear assembly may be arranged such that with the gears transmitting the alternative drive torque while arranged in the first position, the alternative line of action of the gears is substantially parallel to the alternative reaction direction.

In a first preferred embodiment of the invention, there is provided a gear assembly comprising a first gear and a second gear, the gears being complementary conformal gears supported for rotation about respective rotation axes extending through respective centres of the gears,
one of the gears being configured to exert a driving force on the other of said gears,
the gear assembly having an optimum centre distance corresponding to an optimum separation of the centres of the first and the second gears, the first gear being supported by a mounting that allows movement of the first gear towards and/or away from the second gear to minimise any difference between the separation of the centres of the first and second gears, and the optimum centre distance, during use of the gear assembly. The mounting comprises a support arm that is configured to rotatably support the first gear. The mounting may comprise a plurality of support arms. For example, the mounting may comprise two or more support arms.

In a second preferred embodiment of the invention, there is provided a gear assembly comprising a first gear and a second gear, the gears being complementary conformal gears supported for rotation about respective rotation axes extending through respective centres of the gears,
one of the gears being configured to exert a driving force on the other of said gears,
the gear assembly having an optimum centre distance corresponding to an optimum separation of the centres of the first and the second gears,
the first gear being supported by a mounting that allows movement of the first gear towards and/or away from the second gear to minimise any difference between the separation of the centres of the first and second gears, and the optimum centre distance, during use of the gear assembly. The mounting comprises at least one support surface, wherein the first gear comprises an axle which rests on the support surface, the first gear being configured to rotate whilst in contact with the support surface, and wherein the support surface is arranged so that the mounting allows the first gear to move along a predetermined line.

In a third preferred embodiment of the invention, there is provided a gear assembly comprising a first gear and a second gear, the gears being complementary conformal gears supported for rotation about respective rotation axes extending through respective centres of the gears,
one of the gears being configured to exert a driving force on the other of said gears,
the gear assembly having an optimum centre distance corresponding to an optimum separation of the centres of the first and the second gears,
the first gear being supported by a mounting that allows movement of the first gear towards and/or away from the second gear to minimise any difference between the separation of the centres of the first and second gears, and the optimum centre distance, during use of the gear assembly. The mounting comprises at least one support surface and the first gear comprises an axle, the axle being received in a support which rests on the support surface, the first gear being configured to rotate whilst in contact with the support, and wherein the support surface is arranged so that the mounting allows the first gear to move along a predetermined line.

In the second and third preferred embodiments, the axle or support may maintain contact with the support surface through operation (rotation) of the gears, that is to say the axle or support does not rock into and out of contact with the support surface.

Specific embodiments of the present invention will now be described, by way of example only, with reference to the accompanying drawings in which:

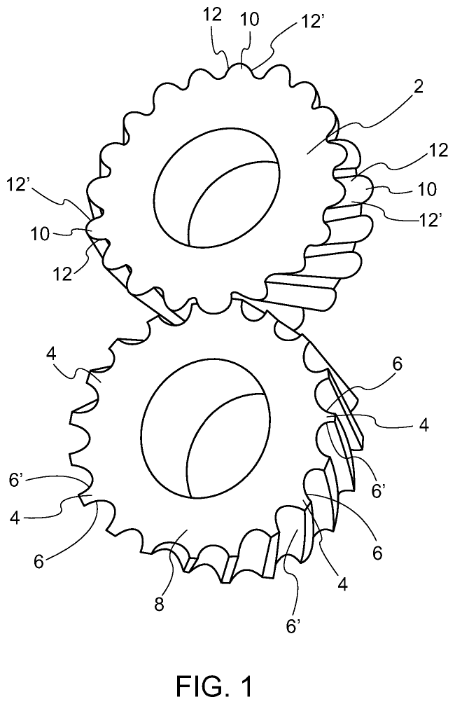

FIG. 1 is a schematic perspective view of a meshed pair of conformal gears;

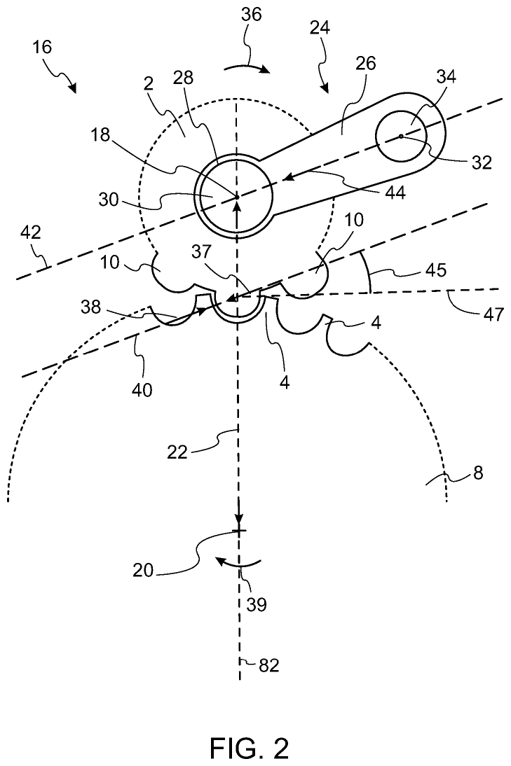

FIG. 2 is a schematic cross-sectional end view of part of a gear assembly of a first embodiment, with first and second gears in a first position;

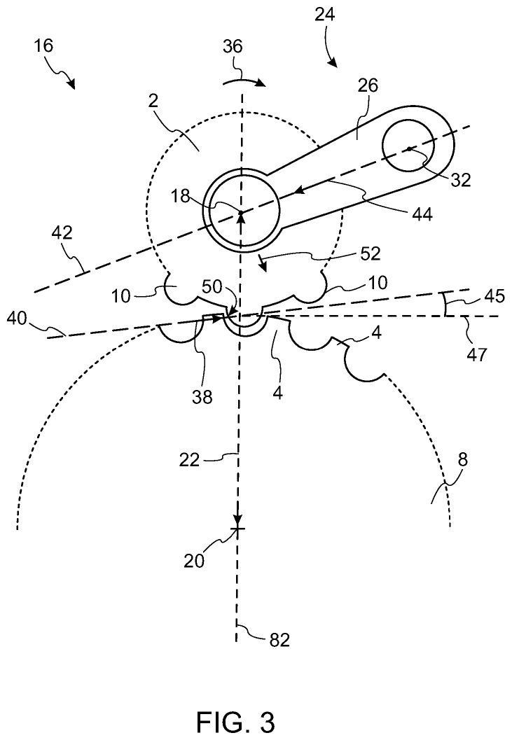

FIG. 3 is a schematic cross-sectional end view of part of the gear assembly of the first embodiment, with the first and second gears further apart than when in the first position;

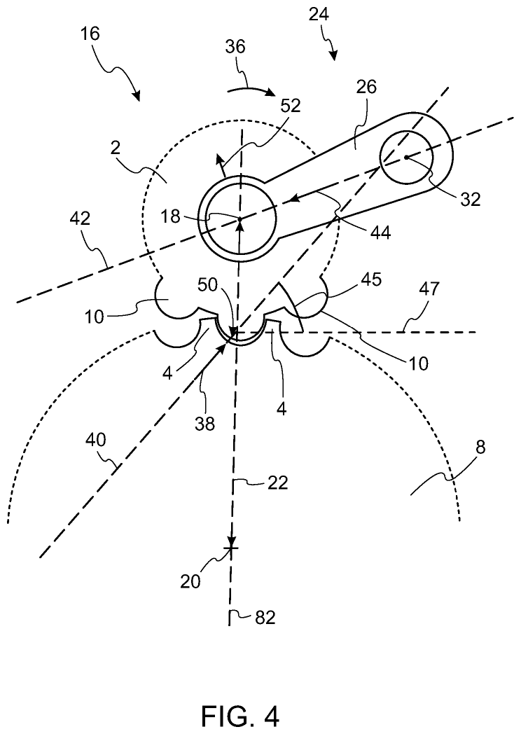

FIG. 4 is a schematic cross-sectional end view of part of the gear assembly of the first embodiment, with the first and second gears closer together than when in the first position;

FIG. 5 is a schematic cross-sectional end view of part of a gear assembly of a second embodiment, with first and second gears in a first position;

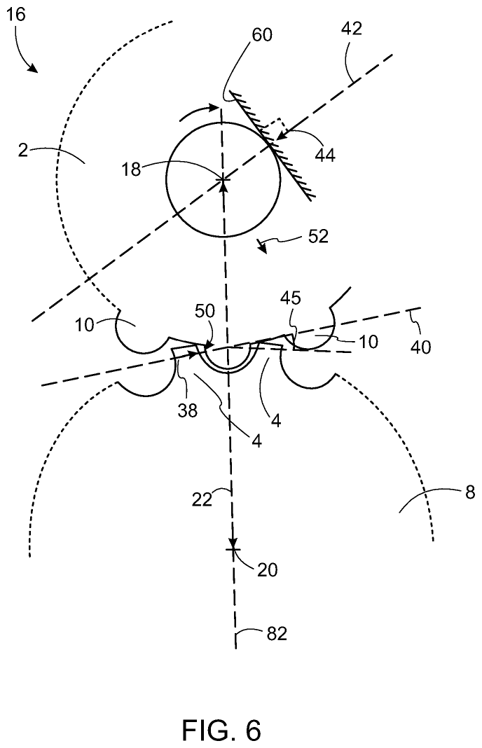

FIG. 6 is a schematic cross-sectional end view of part of the gear assembly of the second embodiment, with the first and second gears further apart than when in the first position;

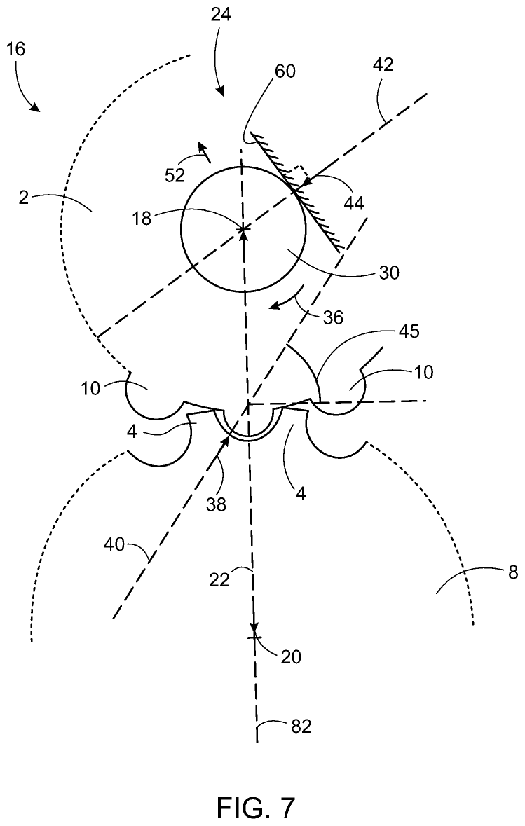

FIG. 7 is a schematic cross-sectional end view of part of the gear assembly of the second embodiment, with the first and second gears closer together than when in the first position;

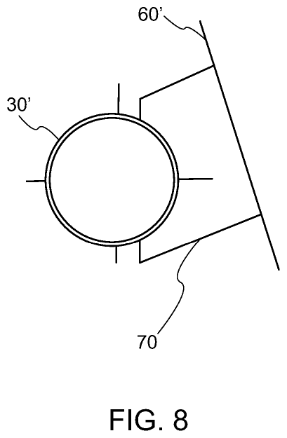

FIG. 8 is a schematic cross-sectional end view of part of a gear assembly of a third embodiment;

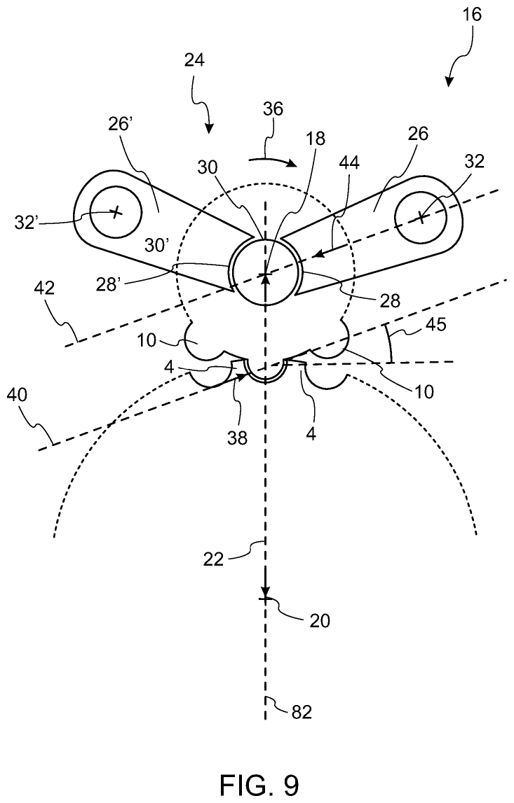

FIG. 9 is a schematic cross-sectional end view of part of a gear assembly of a fourth embodiment, transmitting a drive torque; and

FIG. 10 is a schematic cross-sectional end view of part of the gear assembly of the fourth embodiment, transmitting an alternative drive torque.

Corresponding features within each of the figures have been given the same reference numerals.

An exemplary pair of conformal gears is shown in FIG. 1. The first gear 2 of the pair (shown on top in FIG. 1) has convex teeth 10. Each tooth has a pair of convex flanks 12, 12′. The second gear 8 of the pair has concave teeth 4, each tooth having a pair of concave flanks 6, 6′. The gears 2, 8 shown in FIG. 1 are in a position in which they are at their optimum centre distance, i.e. with their respective teeth 4, 10 optimally meshed. As explained above, the optimum centre distance is the centre distance at which the gear teeth profiles conform, i.e. make contact over the arc from the tooth tip of one gear to the tooth tip of the mating gear. The optimum centre distance may be the centre distance at which the transmission accuracy is maximised, and/or the transmission error is minimised, and/or the transmission of torque (or power) is close to, or at, peak efficiency.

A portion of a gear assembly 16 according to a first embodiment of the invention is shown in FIG. 2. The gear assembly 16 has first and second conformal gears 2, 8 similar to those of FIG. 1. To aid clarity, only some of the teeth 4, 10 are shown. FIG. 2 also shows the axes 18, 20 of the first and second gears 2, 8, and the gears' line of centres 82, and centre distance 22 (shown in smaller dashed line) defined between the axes 18, 20. The gears 2, 8 are shown in a first position, in which they have a first centre distance. In this particular embodiment, the first centre distance is the optimum centre distance of the first and second gears 2, 8. The teeth 4, 10 of the gears 8, 2 are therefore optimally meshed.

The second gear 8 is rotatably mounted within the gear assembly 16, so that it is rotatable about its axis 20 but is substantially immovable in any other direction (e.g. parallel to its axis or in a direction perpendicular to its axis), by conventional means which will not be described here. The first gear 2, however, is mounted using a mounting 24 that allows rotation of the gear 2 about its axis 18 and also limited movement of the gear 2 towards and away from the second gear 8. In this case, the axis 18 of the gear 2 is movable in a direction non-parallel to that axis 18, more particularly in a direction perpendicular to that axis. The first gear 2 is prevented from moving along (i.e. in a direction parallel to) its axis 18 in a conventional manner which will not be described here.

The mounting 24 of this embodiment comprises a support arm 26 with a socket 28 that supports the first gear 2. An axle 30 of the gear 2 is rotatable within the socket 28, which allows the gear to rotate about its axis 18. In this case, the socket 28 takes the form of a loop which encircles the axle 30 of the gear. A bearing (not visible) such as a plain or roller bearing may be present between the axle 30 and the support arm socket 28.

The support arm 26 can pivot (in the plane of the paper from the perspective of FIG. 2) about an arm axis 32 that is defined by a pivot pin 34. The arm axis 32 may be parallel to the axis 18 of the first gear. If the arm 26 pivots about the arm axis 32, the axis 18 of the first gear 2 will move in a circumferential arc about the arm axis 32. Since the axis 18 of the first gear 2 is free to move in this direction, the circumferential direction about the arm axis 32 will be referred to below as a floating direction. Although the axis 18 of the gear 2 can move around the arm axis 32, the arm prevents the gear's axis from moving radially towards (or away from) the arm axis 32 by providing a reaction force as described in more detail below. The radial direction from the arm axis 32 to the first gear's axis 18 will therefore be referred to as a reaction direction 42.

In order to permit rotation of the support arm 26 about arm axis 32, in some embodiments the support arm 26 is provided with a rotational support such as a bushing or bearing assembly or the like. In such embodiments, the support arm 26 may be a stiff member substantially resistant to deformation in either the reaction direction 42 or the floating direction. However, in some embodiments the support arm 26 may be configured such that it is flexible at least in the floating direction. Such flexibility may be provided by the cross-sectional shape, the material composition or surface features of the support arm 26. For example, the support arm 26 may include a plurality of notches distributed along the body of the support arm 26 in the reaction direction 42, the notches being configured to act as leaf springs or ligaments which permit flexibility of the support arm 26 in the floating direction but retaining high stiffness in the reaction direction 42. In such embodiments, the support arm 26 may be cantilevered to a support structure fixed at the arm axis 32. It will be appreciated that such embodiments eliminate the need for pivot / bearing arrangement at the distal end of the support arm 26 relative to the first gear 2, and are therefore less susceptible to fretting corrosion.

In this embodiment, the second gear 8 is the driven gear of the pair, and the first gear 2 is the driver. In other words, the first gear 2 is connected directly or indirectly to a source of torque (for instance a turbine, motor or an engine), and the second gear 8 is connected directly or indirectly to a load (for instance a wheel, flywheel or a propeller). It will be understood by the skilled person that the configuration with the first gear 2 being the driven gear of the pair, and the second gear 8 being the driver, is also possible. The load may also include frictional forces which must be overcome so as to rotate the second gear 8. When a drive torque 36 is applied to the first gear 2 in a first direction (in this case the clockwise direction from the perspective of FIG. 2), the torque causes the gear to rotate in the same direction as the torque. Since the teeth 10 of the first gear 2 are meshed with the teeth 4 of the second gear 8, as the first gear rotates its teeth 10 apply a driving tooth contact force 37 to the teeth 4 of the second gear. This force 37 being exerted on its teeth 4 causes the second gear 8 to rotate (in this case anticlockwise from the perspective of FIG. 2), thereby transferring the torque to the load (not visible) attached thereto. This force also urges the second gear to move generally down and to the left from the perspective of FIG. 2, but this force is reacted by the mounting of the second gear 8 as discussed below.

As a result of rotation of the second gear 8, the load (not visible) applies a resistive torque 39 to the second gear 8. Since rotation of the second gear 8 is resisted by this torque 39, the teeth 4 of the second gear apply a resistive tooth contact force 38 to the teeth 10 of the first gear 2. The force 37 applied by the teeth 10 of the first gear 2 to the teeth 4 of the second gear, and the force 38 applied by the teeth of the second gear to the teeth of the first gear, are equal in magnitude and opposite in direction. The line along which these two forces act is referred to in the art as the line of action 40. Movement of the first gear 2 which would be the result of the force 38 from the second gear would require the first gear 2 to move towards the arm axis 32, and this is prevented by the arm 26 because the arm supplies a reaction force 44 in the reaction direction 42 (i.e. the radial direction) as outlined above. FIG. 2 also shows the pressure angle 45, which is the angle between the line of action 40 and a line 47 perpendicular to the line of centres 82.

In optimally meshed conformal gears the flanks of the gears' teeth bear on each other along a line of contact. However, due to the principle of superposition the combined effect of point loads which act in a direction perpendicular to the flanks of the teeth at all points in contact can be considered as a point load. It is this point load which is shown in FIG. 2. As a further simplification, since in conformal gears the gears 2, 8 act on each other through culmination, the forces between their teeth 10, 4 can be considered to be arranged as shown in FIG. 2 at all times during rotation of the gears, even though the positions of individual teeth will be changing constantly, that is, tooth contact moves axially as the gears rotate.

With the first and second gears 2, 8 arranged in the first position, i.e. at the first centre distance, the reaction direction 42 and the line of action 40 of the gears are substantially parallel. The reaction force 44 and the force 38 applied by the second gear 8 are therefore opposite in direction. Given that these forces are in parallel directions, since the reaction force 44 is provided by the first gear 2 bracing against the arm 26 due to the force 38 from the second gear 8, these forces are also equal in magnitude. Accordingly, the reaction force 44 and the force 38 applied to the first gear 2 by the second gear are in equilibrium. The axis 18 of the first gear 2 therefore remains stationary (while the gear rotates) since there is no unbalanced force acting thereon.

FIG. 3 shows the same components as FIG. 2, but with the gears 2, 8 in a second position, in which they have a second centre distance. This figure shows only the forces and torques exerted on the first gear 2. In this embodiment, the second centre distance is larger than the first centre distance. The axes 18, 20 of the first and second gears 2, 8 are therefore spaced further apart when in the second position than when in the first position. In this case, since the first centre distance is the optimum centre distance, with the gears 8, 2 at this second centre distance their teeth 4, 10 are only partially meshed.

In this case, the larger centre distance 22 is not the result of the arm 26 being in a different position to that shown in FIG. 2. The centre distance being larger than that shown in the previous figure may be a result of thermal expansion meaning that the axis 20 of the second gear 8 is lower (from the perspective of FIG. 3) than is shown in FIG. 2.

With the first and second gears 2, 8 at this second centre distance, their teeth 10, 4 do not bear on each other along a line of contact as described above. Instead, the teeth 4, 10 bear on each other at a single contact point 50. With the teeth 10, 4 of the gears 2, 8 contacting each other in a different fashion to the above, the line of action 40 is also different. More particularly, the larger centre distance 22 results in the line of action 40 being in a position which is closer to perpendicular to the line of centres 82 (i.e. closer to the horizontal from the perspective of FIG. 3). In other words, the pressure angle 45 is smaller.

This behaviour is a distinctive characteristic of conformal gears. In other gears such as involute gears, any increase in centre distance 22 would move the line of action further away from the direction perpendicular to the line of centres 82 (i.e. would increase the pressure angle). In the case of conformal gears however, a relatively small increase in centre distance has the opposite effect.

With the line of action 40 in a different position, the direction of the tooth contact force 38 applied by the second gear 8 is also different. Because the arm 26 is pivotable about the arm axis 32, it can only exert a force in a radial direction. Accordingly, since the angular position of the arm 26 is the same as in FIG. 2, the direction of the reaction force 44 (i.e. the reaction direction 42) is also the same as in FIG. 2. The line of action 40 and the reaction direction 42 are therefore not parallel. The reaction force 44 and the force 38 from the second gear 8 are therefore not opposite in direction, and hence are not in equilibrium. With the reaction force 44 and the force 38 on the first gear 2 from the second gear 8 not in equilibrium, a resultant force 52 is produced. The resultant force 52 acts in a direction shown by arrow 52 which is perpendicular to the reaction direction 42, i.e. it acts in the floating direction.

Since there is an unbalanced force with a component in the floating direction (in this case entirely in the floating direction), the first gear 2 (and thus its axis 18) moves in the floating direction, i.e. generally downwards from the perspective of FIG. 3. The arm 26 pivots about the arm axis 32 to accommodate this movement. This movement of the first gear 2 reduces the centre distance 22 and moves the gears towards the first centre distance.

FIG. 4 shows the same components as FIGS. 2 and 3, but with the gears 2, 8 in a third position, in which they have a third centre distance. As with FIG. 3, this figure shows only the forces and torques exerted on the first gear 2. The third centre distance is smaller than the first centre distance. The axes 18, 20 of the first and second gears 2, 8 are therefore spaced closer together than when in the first position, but still with sufficient backlash to avoid tight mesh. In this case, since the first centre distance is the optimum centre distance, with the gears 8, 2 in this third position (i.e. at the third centre distance) their teeth 4, 10 are over-meshed.

With the first and second gears 2, 8 at this third centre distance, as with when they are at the second centre distance, the teeth 10, 4 bear on each other at a single contact point 50. With the teeth 10, 4 of the gears 2, 8 contacting each other with the gears at a smaller centre distance than the first (i.e. the optimum), the line of action 40 is further from perpendicular to the line of centres 82 (i.e. further from the horizontal from the perspective of FIG. 4) than when the gears are at the first centre distance. In other words, the pressure angle 45 is larger. As with the change in line of action discussed in relation to FIG. 3, this feature is also unique to conformal gears. In other gears, such as involute gears, any reduction in centre distance 22 would decrease the pressure angle.

With the line of action 40 in a different position, the direction of the tooth contact force 38 applied by the second gear 8 is also different. As with the situation with the gears at the second centre distance, because the arm 26 is pivotable about the arm axis 32 it can only exert a force in a radial direction. Accordingly, since the angular position of the arm 26 is the same as in FIG. 2, the direction of the reaction force 44 (i.e. the reaction direction 42) is also the same as in FIG. 2. The line of action 40 and the reaction direction 42 are therefore not parallel. Consequently, a resultant force 52 is produced. The resultant force 52 acts in a direction 54 which is perpendicular to the reaction direction 42, i.e. the floating direction.

Since there is an unbalanced force with a component in the floating direction (in this case entirely in the floating direction), the first gear 2 (and thus its axis 18) moves in the floating direction, generally upwards from the perspective of FIG. 4. The arm 26 pivots about the arm axis 32 to accommodate this movement. This movement of the first gear 2 increases the centre distance 22 and moves the gears towards the first position.

Part of a gear assembly 16 of a second embodiment of the invention is shown in FIG. 5. The gears 2, 8 of the second embodiment are shown at a first position, and as with the previous embodiment the first centre distance (the centre distance of the gears when in this position) is the optimum centre distance. Like in the first embodiment, the second gear 8 is rotatably mounted within the gear assembly 16 in conventional fashion, and the first gear 2 is mounted using a mounting 24 that permits limited movement of its axis 18. In this case, however, the mounting 24 does not have a support arm but instead has a support surface 60 on which the axle 30 of the first gear 2 can rest. The axle 30, and thus the gear 2, can rotate whilst in contact with the support surface 60. The reaction force of the surface on the axle 30 of the first gear 2, and hence the gear itself, acts in a direction perpendicular to the support surface 60. This direction therefore constitutes the reaction direction 42 of this embodiment.

The axle 30 is able to run up and down the support surface 60 (from the perspective of FIG. 5), therefore the axis 18 is movable in a direction parallel to the support surface. This direction constitutes the floating direction of this embodiment. In this case, the support surface 60 is substantially flat in the plane of FIG. 5 (which is a plane normal to the axis of the first gear 2). The floating direction is therefore linear in this embodiment.

In this embodiment, as with the first embodiment, the second gear 8 is the driven gear of the pair and the first gear 2 is the driver. During transmission of the driving torque 36, movement of the first gear 2 which would be the result of the force 38 from the second gear 8 would require the first gear 2 to move beyond the support surface 60, and this is prevented by the support surface. The support surface 60 applies a reaction force 44 in the direction normal to the surface, i.e. in the reaction direction 42.

As with the first embodiment, with the first and second gears 2, 8 arranged at the first centre distance the reaction direction 42 and the line of action 40 of the gears are substantially parallel. The reaction force 44 and the force 38 applied by the second gear 8 are therefore opposite in direction. Also, given that these forces are in parallel directions, since the reaction force 44 is provided by the first gear 2 bracing against the support surface 60 due to the force 38 from the second gear 8, these forces are equal in magnitude. Accordingly, the force 38 applied to the first gear 2 by the second gear, and the reaction force 44, are in equilibrium. The axis 18 of the first gear 2 therefore remains stationary while the gear rotates.

FIG. 6 shows the same components as FIG. 5, but with the first and second gears 2, 8 in a second position, in which they have a second centre distance which is larger than the first centre distance. The teeth 4, 10 of the gears are therefore only partially meshed. As with the first embodiment, with the first and second gears 2, 8 at the second centre distance their teeth 10, 4 bear on each other at a single contact point 50, and the pressure angle 45 is smaller. The force 38 applied by the second gear to the first gear is therefore in a different direction. The support surface can only apply the reaction force 44 to the gear 2 in a normal direction, i.e. in the reaction direction 42. The reaction force 44 and the force 38 from the second gear 8 are therefore not opposite in direction, thus there is no equilibrium and a resultant force 52 is produced. The resultant force 52 moves the first gear 2 along the support surface 60 in the floating direction, moving the gears 2, 8 towards one another and towards the first centre distance.

FIG. 7 shows the same components as FIGS. 5 and 6, but with the first and second gears at a third position, in which their centre distance (the third centre distance) is smaller than the first centre distance. The gears' axes are therefore spaced closer together than the first centre distance, and so their teeth 4, 10 are over-meshed and the pressure angle 45 is larger. The force 38 applied by the second gear to the first gear is therefore in a different direction, and a resultant force 52 is produced which moves the first gear 2 along the support surface 60 in the floating direction (i.e. generally upwards from the perspective of FIG. 7). This acts so as to move the gears further apart, away from the third position and towards the first position.

FIG. 8 schematically shows a similar arrangement to FIGS. 5 to 7 with a support surface 60′ provided to guide movement of an axle 30′, however, the embodiment shown in FIG. 8 includes a support 70, which includes a concave surface or formation that is shaped to receive the axle 30′ or its bearing and permit rotation of the axle 30′ about its axis relative to the support 70, and an opposite surface that contacts the support surface 60′. It will be appreciated that the size, shape and configuration of the support 70 can take any particular form provided it can support the axle 30′ while permitting rotation of the axle 30′ relative to the support 70, and provide a suitable contact surface to engage support surface 60′ so that the support 70 can move across support surface 60′. The support 70 differs from roller bearings, where the bearing housing remains in a fixed axial position relative to the gear axle. Instead, the support 70 need not surround the entirety of an axle 30′ and can move in a direction along the length of the axle 30′. The support 70 may be referred to as a mounting block or a retaining element. A portion of a gear assembly 16 according to a fourth embodiment of the invention is shown in FIG. 9. As with the first embodiment, the first gear 2 is mounted using a mounting 24 which comprises a support arm 26, which is pivotable about an arm axis 32 and has a socket 28 that supports the axle 30 of the first gear 2. However, in this case, the socket 28 takes the form of a dished surface within which the axle 30 of the first gear 2 can rest. In other words, the socket 28 in this embodiment merely ‘cups’ the axle 30 of the gear 2, rather than encircling it. Nonetheless, the first gear 2 can rotate about its axis 18 within the socket 28 (for instance by virtue of a bearing positioned therebetween). However, since the socket 28 is shaped so that the gear 2 (in this case the axle 30 thereof) can be withdrawn therefrom, in this embodiment the gear 2 is not permanently rotatably coupled to the support arm 26. If a drive torque 36 is applied to the first gear 2, the support arm 26 enables self-centring in the same manner as described in relation to the support arm of the first embodiment.

Unlike the first embodiment, the mounting 24 also comprises a second support arm 26′. In this particular embodiment, the second support arm 26′ is a mirror image of the support arm 26. Just as the arm 26 allows the first gear 2 to move so that the gears can move towards the first position when a drive torque is applied in one direction (clockwise in this case), the second arm 26′ allows the first gear 2 to move so that the gears can move towards the first position when a drive torque in the opposite direction (anticlockwise in this case) is present.

FIG. 10 shows the same components as FIG. 9, but with the gears 2, 8 transmitting an alternative drive torque 36′. Again, the gears 2, 8 are shown in the first position, at the first (i.e. optimum) centre distance. When the alternative drive torque 36′ is applied, the first and second gears 2, 8 counter-rotate in the opposite direction to when the drive torque is applied, and the line of action is therefore different. The line of action through which the gears 2, 8 act when transmitting the alternative drive torque 36′ will be referred to as the alternative line of action 40′. Application of the alternative drive torque 36′ causes the first gear 2 to rotate, and the teeth 10 of the gear apply an alternative drive force (not shown) to the teeth 4 of the second gear 8 along the alternative line of action 40′. The alternative drive force on the teeth 4 of the second gear 8 causes the second gear to rotate (clockwise from the perspective of FIG. 10), thereby transferring the torque to the load (not visible) attached thereto. Since rotation of the second gear 8 is resisted by the load, the teeth 4 of the second gear apply an alternative resistive force 38′ to the teeth 10 of the first gear 2 along the alternative line of action 40′. This force 38′ urges the first gear 2 generally up and to the left from the perspective of FIG. 10, towards the second arm axis 32′. The second support arm 26′ resists this movement in the manner outlined above, and applies an alternative reaction force 44′ to the first gear 2 in the alternative reaction direction 42′. The second support arm 26′ allows self-centering of the gears 2, 8 when transmitting the alternative driving torque 36′ in the same manner as the support arm 26 when the gears are transmitting the drive torque, and will not be described in detail here.

It will be appreciated that the principle of providing support for rotation of the first gear 2 in both the clockwise and anti-clockwise directions, as described above in relation to the fourth embodiment of the invention, may be extended to define further embodiments of the invention. For example, in a further embodiment a gear assembly may be provided which comprises two support surfaces in the manner of the support surface 60 of the second embodiment of the invention or support surface 60′ of the third embodiment of the invention. The support surfaces may be provided on opposite sides of the first gear 2 in the same manner as the support arm 26 and second support arm 26′ of the fourth embodiment. That is to say, in such an embodiment the axle 30 may be configured to run up and down a first one of the support surfaces to define the floating direction under clockwise torque, and further configured to run up and down a second one of the support surfaces to define the floating direction under anti-clockwise torque. Similarly, the support 70, which rotatably supports axle 30′, may be configured to run up and down a first one of the support surfaces to define the floating direction under clockwise torque, and further configured to run up and down a second one of the support surfaces to define the floating direction under anti-clockwise torque.

In some applications, the gear assembly may be required to transfer a large load in one direction of rotation and a comparatively small load in the opposite direction of rotation. For example, during use, deceleration of the driver gear may cause a load to be applied to the driven gear in a reverse direction relative to the direction of rotation of the driver gear. As such, further embodiments of the gear assembly may comprise a mounting which allows relative movement between the first and second gears 2, 8 for loading in the direction of the driving torque whilst substantially preventing relative movement between the first and second gears 2, 8 for loading in the reverse direction. For example, the mounting may comprise a fixed support (such as a mechanical stop, semi-circular bearing or the like) configured to counteract a floating support (such as a support arm and/or a support surface).

A further embodiment of the gear assembly may comprise a support arm 26 which is configured to work under tension, in contrast to the first embodiment of the invention which comprises a support arm 26 configured to work under compression. In such embodiments, the support arm 26 should be positioned on the diametrically opposite side of the first gear 2 as the support arm 26 of the first embodiment. Such embodiments may be particularly suited for use with flexible, rather than stiff, support arms and/or to make the gear assembly more compact. It will further be appreciated that in some embodiments a combination of a first support arm 26 acting in tension and a second support arm 26 (or support surface 60) acting in compression may be provided. Where two sets of support arms 26, 26′ are provided (i.e. for rotation in two directions) in which at least one support arm 26, 26′ acts in tension, the sockets 28 of each support arm 26, 26′ must be axially spaced along the axle 30.

As would be understood by those skilled in the art, during use the film thickness of a lubricant applied between the first and second gears 2, 8 will be negligible towards the tips and/or roots of the teeth 4, 10. As such, in some embodiments of the gear assembly it may be preferable to provide tip and/or root relief on the teeth 4, 10 of the first and/or second gears 2, 8.

In the above-described embodiments, the first gear 2 is the driver and the second gear 8 is the driven gear. However, it will be understood by the skilled person that it is also possible that the first gear 2 is the driven gear of the pair, and the second gear 8 is the driver.

The described and illustrated embodiments are to be considered as illustrative and not restrictive in character, it being understood that only preferred embodiments have been shown and described and that all changes and modifications that come within the scope of the inventions as defined in the claims are desired to be protected.

It is to be noted that in all the above embodiments, in order for the first and second gears 2, 8 to mesh correctly, their respective axes of rotation 18, 20 are substantially parallel to one another, although it will be appreciated that this does not always have to be the case and that in other embodiments, not shown here, the axes of rotation of the first and second gears do not have to be substantially parallel to mesh correctly with one another. In the above embodiments in which the respective axes 18, 20 are substantially parallel, it is preferable that the first and second gears 2, 8 are supported axially either side of the gears 2, 8. Such support may be achieved for example by mirroring the mounting arrangements of the above described embodiments on the axially distal side of the gears 2, 8. In particular, it will be appreciated that for the sake of clarity the first gear 2 is only shown as being supported on one axial side (i.e. in each embodiment the first gear 2 is shown further into the page than the support arms 26 or support surfaces 60). However, in most circumstances the first gear will be supported on both sides, such as for instance by a support arm shaped like a bicycle wheel fork or a yoke. So as to ensure the yoke holds the first gear 2 in a stable position, the support arms 26 of the yoke should preferably be formed as one piece or as separate pieces joined at their distal ends.

1. A gear assembly comprising a first gear and a second gear, the gears being complementary conformal gears supported for rotation about respective rotation axes extending through respective centres of the gears,
one of the gears being configured to exert a driving force on the other of said gears,
the gear assembly having an optimum centre distance corresponding to an optimum separation of the centres of the first and the second gears,
the first gear being supported by a mounting that allows movement of the first gear towards and/or away from the second gear to minimise any difference between the separation of the centres of the first and second gears, and the optimum centre distance, during use of the gear assembly.

2. The gear assembly according to claim 1 wherein the optimum centre distance is the centre distance at which gear teeth profiles of the first and second gears conform.

3. The gear assembly according to claim 1 wherein the first gear exerts the driving force on the second gear or vice versa.

4. The gear assembly according to claim 1 wherein the mounting comprises a support arm configured to rotatably support the first gear.

5. The gear assembly according to claim 4, wherein the support arm is pivotable about an arm axis so as to move the first gear towards and/or away from the second gear.

6. The gear assembly according to claim 4 wherein the support arm comprises a pivot pin, defining an arm axis about which the support arm rotates, the arm axis being parallel to the rotation axis of the first gear.

7. The gear assembly according to claim 4 wherein the support arm comprises a socket, the first gear comprises an axle, and the axle is rotatable within the socket, and wherein the socket forms a loop which encircles the axle of the first gear.

8. The gear assembly according to claim 4 wherein the mounting comprises a plurality of support arms, for example two or more support arms.

9. The gear assembly according to claim 8 wherein the support arm is flexible, such that bending of the support arm permits movement of the first gear relative to the second gear, and
wherein the flexibility is provided as a result of a cross-sectional shape, material composition, surface features or any other suitable characteristic of the support arm.

10. (canceled)

11. The gear assembly according to claim 1 wherein the mounting comprises at least one support surface, wherein the first gear comprises an axle which rests on the support surface, the first gear being configured to rotate whilst in contact with the support surface, and wherein the support surface is arranged so that the mounting allows the first gear to move along a predetermined line, and
wherein the axle is able to run along the support surface, and wherein consequently an axis of the first gear is movable in a direction parallel to the support surface.

12. (canceled)

13. The gear assembly according to claim 1 wherein the mounting comprises at least one support surface and the first gear comprises an axle, the axle being received in a support which rests on the support surface, the first gear being configured to rotate whilst in contact with the support, and wherein the support surface is arranged so that the mounting allows the first gear to move along a predetermined line, and
wherein the axle is able to run along the support surface, and wherein consequently an axis of the first gear is movable in a direction parallel to the support surface.

14. (canceled)

15. The gear assembly according to claim 11 wherein the mounting comprises a plurality of support surfaces, for example two or more support surfaces.

16. A gear assembly comprising a first gear and a second gear, the gears being complementary conformal gears supported for rotation about respective rotation axes, wherein:
one of the gears is configured to receive a drive torque and exert a driving tooth contact force, along a line of action, on the other of said gears via engagement of teeth of each of the first and second gears, so as to transmit the drive torque to the other of said gears, said other of the gears exerting a resistive tooth contact force to said one of the gears, along the line of action, as a consequence of the drive torque;
the first gear is supported by a mounting which is configured to allow movement of the rotation axis of the first gear, and to exert a reaction force on the first gear in a reaction direction during transmission of the drive torque from said one of the gears to the other of the gears;
the first and second gears can take a first position relative to one another in which they have a first centre distance, and a second position in which they have a second centre distance;
the gear assembly is configured such that with the gears transmitting the drive torque while positioned in the second position, the line of action of the gears is not parallel to the reaction direction such that the reaction force, and the one of the driving tooth contact force and the resistive tooth contact force which is exerted on the first gear, produce a resultant force on the first gear; and
the resultant force urges the first gear to move relative to the second gear so as to move the gears away from the second position and towards the first position.

17. The gear assembly according to claim 16 wherein the first centre distance is substantially equal to the optimum centre distance of the first and second gears.

18. The gear assembly according to claim 16 wherein:
the first and second gears can take a third position relative to one another in which they have a third centre distance, the first centre distance being between the second and third centre distances;
the gear assembly is configured such that with the gears transmitting the drive torque while arranged at the third position, the line of action of the gears is not parallel to the reaction direction such that the reaction force, and the one of the driving tooth contact force and the resistive tooth contact force which is exerted on the first gear, produce a resultant force on the first gear; and
the resultant force urges the first gear to move relative to the second gear so as to move the gears away from the third position and towards the first position.

19. The gear assembly according to claim 16 wherein the gear assembly is arranged such that with the gears transmitting the drive torque while arranged in the first position, the line of action of the gears is substantially parallel to the reaction direction, and
wherein the mounting comprises a support arm which is configured to rotatably support the first gear and which is pivotable about an arm axis, wherein the reaction direction is the direction between the arm axis and an axis of the first gear.

20. (canceled)

21. The gear assembly according to claim 16 wherein the first gear is supported by a support surface, the reaction direction being perpendicular to the support surface, and the first gear being movable in a direction parallel to the support surface when supported by the support surface.

22. The gear assembly according to claim 16 wherein:
said one of the gears is further configured to receive an alternative drive torque and exert an alternative driving tooth contact force, along an alternative line of action, on the other of said gears via engagement of teeth of each of the first and second gears, so as to transmit the alternative drive torque to the other of said gears, said other of the gears exerting an alternative resistive tooth contact force to said one of the gears, along the alternative line of action, as a consequence of the alternative driving tooth contact force;
the mounting is further configured to exert an alternative reaction force on the first gear in an alternative reaction direction during transmission of the alternative drive torque from the one of the gears to the other of the gears;
the gear assembly is configured such that with the gears transmitting the alternative drive torque while arranged in the second position, the alternative line of action of the gears is not parallel to the alternative reaction direction such that the alternative reaction force, and the one of the alternative driving tooth contact force and the alternative resistive tooth contact force which is exerted on the first gear, produce an alternative resultant force on the first gear; and
the alternative resultant force urges the first gear to move relative to the second gear so as to move the gears away from the second position and towards the first position.

23. The gear assembly according to preceding claim 1 wherein the gears are Wildhaber-Novikov gears.

24. The gear assembly according to claim 11, wherein the axle is in direct contact with the support surface.
